(19) United States
(12) Patent Application Publication
(10) Pub. No.: US 2014/0136950 A1
(43) Pub. Date: May 15, 2014

(54) Method for Sharing and Tracking Comments on a Webpage

(71) Applicant: RICHPLAY INFORMATION CO., LTD., New Taipei City (TW)

(72) Inventors: Hai-Tao WO, Shanghai City (CN); Yi-Hsiang CHEN, New Taipei City (TW)

(73) Assignee: RICHPLAY INFORMATION CO., LTD., New Taipei City (TW)

(21) Appl. No.: 13/890,706

(22) Filed: May 9, 2013

(30) Foreign Application Priority Data
Nov. 15, 2012 (TW) 101142546

(51) Int. Cl. H04L 29/08

(52) U.S. Cl. CPC H04L 67/22
USPC 715/234

(57) ABSTRACT

A method for sharing and tracking comments on a webpage comprises steps of reading a webpage via a first device reading a webpage, accessing at least one comment according to at least one piece of website information of the webpage from a second server or from at least one third device, and then displaying the webpage and the comment on the first device concurrently. Generating the comment includes steps of reading the webpage and generating the comment corresponding to the website information via a second device, and then applying the second server to save the comment and the website information. The present method allows users to share their comments corresponding to the webpage with each other and allows users to follow a specific webpage or a specific user's account and to manage a authorized user list.

### 1. FIELD OF THE INVENTION

The present invention relates to a method for sharing and tracking comments on a webpage, particularly to a method that users are able to comment on the webpage and share the comment to all or a part of users. The method also allows users to track and share a new comment generated on the webpage associated with a certain target.

### 2. DESCRIPTION OF THE RELATED ART

Nowadays we use Internet for a longer time, and Internet gradually becomes one of the most important sources where people acquire information. Herein, when users surf the Net for acquiring information, some thoughts may be brought about. While these thoughts are to be stated or communicated with other users, users may post their comments through the commenting mechanism provided by the webpage or forward the website or the content of the webpage to their own website, such as the personal blog, or the personal website in a community. Accordingly, users thence state their thoughts through the commenting mechanism provided by these websites and communicate with other users through leaving messages.

Apparently, if users want to leave a message on the webpage, they have to utilize the commenting mechanism built in the webpage. However, some of the webpages provide the commenting mechanism but require users register an account belonging to the website. This registering process is somewhat complicated, and users have to memorize every account and password in accordance with different websites, which is troublesome and impractical while today's Internet is so immense. Although there are some websites allows users to comment anonymously or freely, those websites still require users leave a byname to comment. Wherein, the byname is easily repeated. Moreover, when users leave less information, it is more difficult for them to communicate or track each other.

Moreover, those users who forward the website or the content of the webpage to their own personal spaces on the Internet can only elaborate their thoughts as well as communicate with other users while the communication is conducted within a group of familiar users. However, the forwarded content of the webpage can be surfed only when the accordant website is connected externally. Accordingly, users have to switch the webpages, windows, or bookmarks they are surfing repeatedly so as to compare the messages in the original webpage with their thoughts, which is quite inconvenient. Even worse, randomly forwarding others' websites may infringe the intellectual property.

As a result, the inventor of the present invention endeavors to develop a method that users are able to leave their comments on any webpages and share their thoughts to all or a part of other users since the current commenting mechanism on the webpages is quite inconvenient. Wherein, a platform is provided other than the webpage that users are surfing, so that users are able to comment on the content of the webpage while the thoughts of users and the original content of the webpage are concurrently displayed. Accordingly, it is easier for other users to read and compare the messages on the webpage.

Thus, the present invention provides a method for sharing and tracking comments on a webpage including steps of a first device reading a webpage and accessing at least one comment corresponding to at least one piece of website information of the webpage from a second server or at least one third device. The webpage and the comment are concurrently displayed on the first device. Generating the comment includes reading the webpage via a second device and applying the second device to generate the comment corresponding to the website information of the webpage. The second server saves the comment and the website information. Wherein, the website information includes a website address of the webpage, at least one paragraph of the webpage, at least one picture of the webpage, at least one video of the webpage, at least one piece of embedded external information of the webpage, or at least one external website address of the webpage. In operation, users are able to make comments about the content of the webpage and share the comments to all or a part of users while surfing the Net. These comments are made corresponding to the website of the webpage and they are correlated to the content of the webpage. Namely, when the content of the webpage is forwarded or cited, the webpage that displays the forwarded or cited webpage can also read the correlated comments, so that the comments can be read by more users. Therefore, the comments can be popularly shared and broadcasted. Additionally, the comments can be accessed not only from the server that saves the comments but also from other users' devices. Thereby, the loading of the server can be lessened, and the comments can be read more efficiently. The present invention also allows certain accounts or certain webpages to be tracked. Namely, users can timely follow the latest comments made by the certain accounts or made on the certain webpages.

### SUMMARY OF THE INVENTION

The object of the present invention is to provide a method for sharing and tracking comments on a webpage, so that users can read the comments corresponding to the webpage while the webpage and the comments are displayed concurrently.

A further object of the present invention is to provide a method for sharing and tracking comments on a webpage, so that users can generate comments corresponding to the content of the webpage while surfing the Net and share the comments with other users.

A further object of the present invention is to provide a method for sharing and tracking comments on a webpage, so that users can list a certain user's account or a certain content of the webpage as a tracking target. Thereby, users can timely follow the comments posted by the certain user's account or the comments made on the certain content of the webpage.

A further object of the present invention is to provide a method for sharing and tracking comments on a webpage, so that users can give authority to other users by listing them in an authorized user list or requiring them enter a code so as to limit the right of other users to read the comments.

The method for sharing and tracking comments on a webpage in accordance with the present invention comprises steps of a first device reading a webpage; and the first device accessing at least one comment corresponding to the webpage according to at least one piece of website information of the webpage from a second server or at least one third device; the webpage and the comment being concurrently displayed on the first device.

Generating the comment includes steps of reading the webpage via a second device; and applying the second device to generate the comment corresponding to the website information of the webpage; the second server accessing and saving the comment and the website information.

Preferably, the website information includes a website address of the webpage, at least one paragraph of the webpage, at least one picture of the webpage, at least one video of the webpage, at least one piece of embedded external information of the webpage, or at least one external website address of the webpage.

In view of afore arrangement, the present invention allows the comments corresponding to the content of the webpage to be concurrently displayed while users are surfing the Net. Thereby, users can access the comments that are made corresponding to the content of the webpage by other users or by themselves. Wherein, the comments can be some related information, reflections, thoughts, opinions, evaluation, questions, or answers. The present invention also allows users to post their comments corresponding to the content of the webpage and share the comments to all or a part of other users. Namely, the present invention can be served as a communication platform for users to share their related information, reflections, thoughts, opinions, evaluation, questions, or answers corresponding to the webpage with each other.

Further, while the present invention utilize an account to login the second server and set a certain user's account or a certain content of the webpage to be a tracking target, users can timely follow the comments made by certain user's account or the comments made on the certain content of the webpage. Namely, the present invention further utilizes the communication platform for commenting on the webpage to develop a thorough community in Internet for interaction.

### BRIEF DESCRIPTION OF THE DRAWINGS

FIG. 1 is a schematic view showing a first preferred embodiment of the present invention in reading a comment;

FIG. 2 is a flowchart showing the first preferred embodiment of the present invention in reading the comment;

FIG. 3 is a schematic view showing the first preferred embodiment of the present invention in generating the comment;

FIG. 4 is a flowchart showing the first preferred embodiment of the present invention in generating the comment;

FIG. 5 is a schematic view showing a second preferred embodiment of the present invention in setting a tracking function;

FIG. 6 is a flowchart showing the second preferred embodiment of the present invention in setting the tracking function;

FIG. 7A is a first schematic view showing a third preferred embodiment of the present invention in setting the comment;

FIG. 7B is a second schematic view showing the third preferred embodiment of the present invention in setting the comment;

FIG. 8 is a flowchart showing the third preferred embodiment of the present invention in setting the comment; and

FIG. 9 is a schematic view showing elements in a fourth preferred embodiment of the present invention.

### DETAILED DESCRIPTION OF THE PREFERRED EMBODIMENTS

The advantages of the present invention over the known prior art will become more apparent to those of ordinary skilled in the art upon reading the following descriptions in junction with the accompanying drawings.

Features of the method of the present invention are that users can access the comments displayed corresponding to the content of the webpage while they are surfing the Net. Accordingly, users can share the comments made on the webpage so as to communicate with each other. Users can also decide if other users can read the comments or not by giving limiting authority through restricting the certain users to an authorized user list or through requiring users enter a code. Moreover, the present invention also allows users to list a certain user's account or a certain content of a webpage into a tracking target, so that users can timely follow the comments made by the certain user's account or made corresponding to the certain content of the webpage.

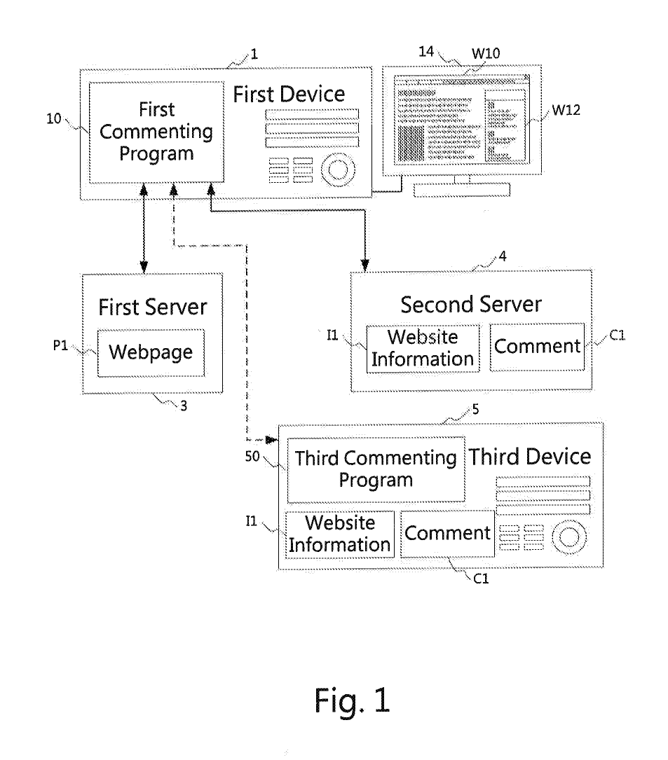

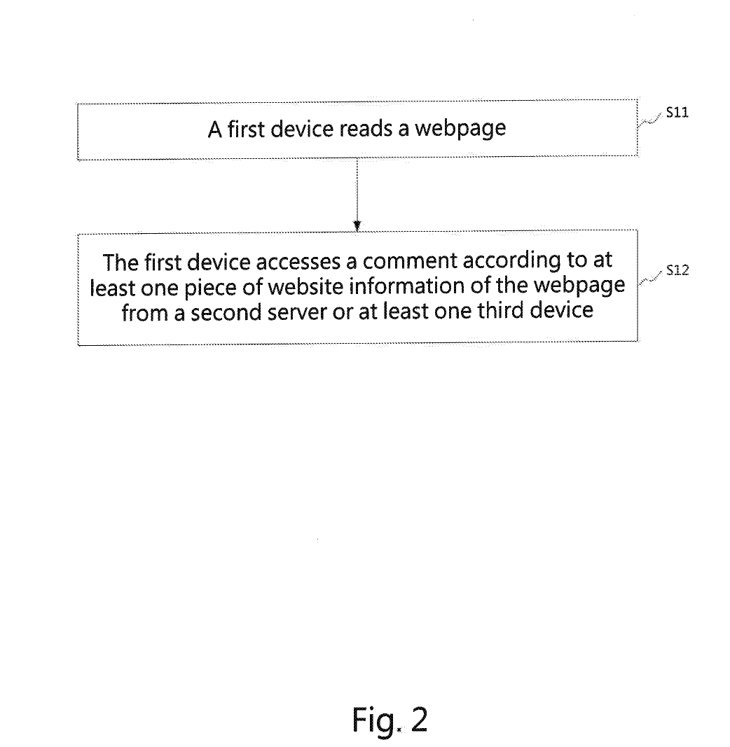

Referring to FIGS. 1 and 2, a flowchart of the present invention shows that comments are read in a first preferred embodiment. Referring to FIG. 1, the method of the present invention for reading the comments comprises a first device 1, a first server 3, a second server 4, and a third device 5. The first device 1 is respectively connected to the first server 3, the second server 4, and the third device 5.

The first server 3 saves a webpage P1, and the second server 4 saves a piece of website information I1 and a comment C1. The website information I1 is retrieved from the webpage P1, and the comment C1 is corresponding to the website information I1. The third device also saves the website information I1 and the comment C1. The website information I1 is retrieved from the webpage P1 or from the second server 4, and the comment C1 is accessed from the second server 4.

The website information I1 includes a website address of the webpage P1, at least one paragraph of the webpage P1, at least one picture of the webpage P1, at least one video of the webpage P1, at least one piece of embedded external information of the webpage P1, or at least one external website address of the webpage P1.

Referring to FIG. 2, steps for reading the comments are as follows:

Step S11: a first device reads a webpage; and

Step S12: the first device accesses a comment according to at least one piece of website information of the webpage from a second server or at least one third device. Accordingly, the webpage and the comment can be displayed on the first device concurrently.

In the step S11, the first device 1 is connected to the first server 3 so as to read the webpage P1 saved in the first server 3. Alternatively, the webpage P1 can be also read from the second server 4 or the first device 1 that saves the webpage P1 accessed from the first server 3.

Subsequently, in the step S12, the first device 1 accesses the comment C1 corresponding to the website information I1 from the second server 4 or the third device 5. The step S12 can be attained via three ways. First, the first device 1 sends the website information I1 retrieved from the webpage P1 to the second server 4. The second server 4 accesses the comment C1 searched from the website information I1 and sends the comment C1 back to the first device 1. Second, the first device 1 sends the website information I1 retrieved from the webpage P1 to the second server 4. The second server 4 thence arranges the third device 5 to connect to the first device 1 according to the website information I1. Accordingly, the third device 5 is allowed to send the comment C1 to the first device 1. Third, the third device 5 receives the website information I1 from the first device 1 and thence sends the comment C1 to the first device 1. After the first device 1 accesses the comment C1 from the second server 4 or the third device 5, the comment C1 and the webpage P1 can be displayed on the first device 1 concurrently.

The third device 5 can similarly access and save the comment C1 from the second server 4 through the steps S11˜S12. Accordingly, the comment C1 is transmitted through the peer-to-peer (P2P) technique to the first device 1 or other devices that have to read the comment C1. Further, if the first device 1 saves the comment C1, the comment C1 can be also sent to other devices while other devices are reading the comment C1. Namely, the connection and the transmission among the non-server devices allow the comment C1 to be shared, so that the loading of the second server 4 can be lessened.

This preferred embodiment of the present invention further comprises a first commenting program executed in the first device 1. The first device 1 comprises a first display device 14, and a third commenting program 50 executed in the third device 5. The first device 1 is respectively connected to the first server 3 and the second server 4 or the third device 5 through the first commenting program 10. The first device 1 further reads the webpage P1, retrieves the website information I1, sends the website information I1 and reads the comment C1 through the first commenting program 10. The third device 5 sends the comment C1 to the first device 1 through the third commenting program 50. The first, commenting program 10 is shown in a first main window W10 and a first sub window W12 of the first display device 14 while being executed in the first device 1. Herein, the webpage P1 is displayed in the first main window W10, and the comment C1 is displayed in the first sub window W12. The first sub window W12 can be overlapped on the first main window W10 or parallel thereto. Thereby, users can conveniently read the comment C1 and compare the comment C1 with the webpage P1, or users can read the webpage P1 and compare the webpage P1 with the comment C1. Herein, the first commenting program 10 can be a particular Internet explorer or a current Internet explorer (such as IE, Firefox, Chrome, safari, Opera, and etc.) When the Internet explorer cooperates with an explorer plugin that is able to retrieve the website information and read the comment, other means for surfing the webpage and reading the comment at the same time is also achievable.

Through steps S11˜S12, a first user is connected to each first server 3 through the first device 1 for reading the webpage P1 saved in each server. The first user can be further connected to the second server 4 for reading the webpage P1 accessed and saved in each first server 3 via the second server 4. Alternatively, the first user can read the webpage P1 accessed and saved from the first server 3 via the first device 1. Accordingly, the comment C1 corresponding to the website information I1 of the webpage P1 is accessed via the second server 4 or each third device 5. Thereby, the comment C1 and the webpage P1 are concurrently displayed, so that the first user can compare and read the webpage P1 as well as the comment C1 in the same time. In this preferred embodiment, the comment C1 is generated from the second device 2 and saved in the second server 4 by a second user. Generating the comment C1 includes steps depicted as follows.

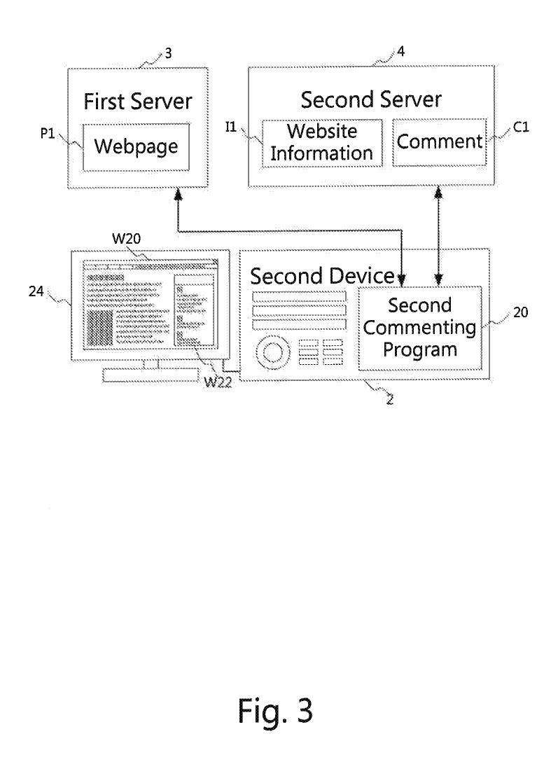

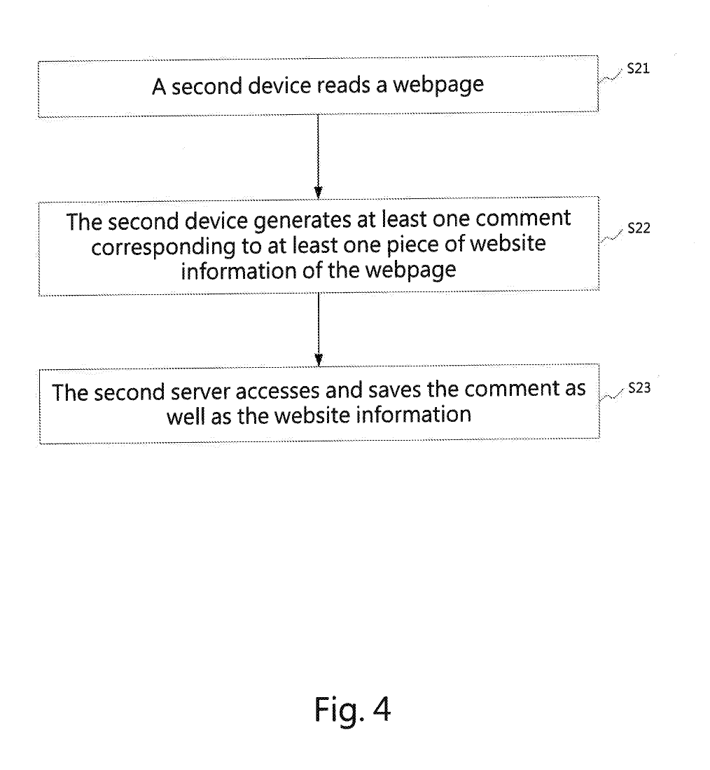

Accompanying with FIGS. 3 and 4, a flowchart of the first preferred embodiment of the present invention is shown to generate the comment. Referring to FIG. 3, a method for generating the comment comprises a second device 2, a first server 3, and a second server 4. The second device 2 is respectively connected to the first server 3 and the second server 4.

The first server 3 saves a webpage P1. The second server 4 saves a piece of website information I1 and a comment C1 after the generating process is completed. The website information I1 is retrieved from the webpage P1, and the comment C1 is corresponding to the website information I1.

Similarly, the website information I1 includes a website address of the webpage P1, at least one paragraph of the webpage P1, at least one picture of the webpage P1, at least one video of the webpage P1, at least one piece of embedded external information of the webpage P1, or at least one external website address of the webpage P1.

Referring to FIG. 4, the comment in accordance with the present invention is generated as follows.

Step S21: a second device reads a webpage;

Step S22: the second device generates at least one comment corresponding to at least one piece of website information of the webpage; and

Step S23: the second server accesses and saves the comment as well as the website information.

Herein, the steps S21˜S23 are executed before the step S12.

In the step S21, the second device 2 is connected to the first server 3 and reads the webpage P1 saved in the first server 3. Alternatively, the second device 2 can also read the webpage P1 that is accessed from the first server 3 and saved in the second server 4 or in the second device 2.

Subsequently, in the step S22, the second device 2 generates the comment C1 corresponding to the website information I1 retrieved from the webpage P1. In the step S23, the second device 2 sends the comment C1 and the website information I1 to the second server 4, and the second server 4 preferably saves the comment C1 and the website information I1. Herein, the comment C1 is made corresponding to the website information I1.

After step S21 and before step S22, a step S220 is conducted. In the step S220, the second device 2 sends the website information I1 retrieved from the webpage P1 to the second server 4. The second server 4 searches the comment related to the website information I1 according to the website information I1. Herein, since no comment record related to the website information I1 is built before, the second sub window W22 displays no annotation.

After the step S22, a step S222 is additionally conducted. In the step S222, the second server 4 conducts searching according to the website information I1 so as to acquire the comment C1 and other new comments related to the website information I1. The acquired comments are thence sent to the second device 2, and the comments and the webpage P1 are displayed on the second device 2 at the same time. This step allows the second device 2 to repeatedly update the comments corresponding to the website information I1 and added to the second device 2.

Referring to FIG. 3, a second commenting program 20 is further executed in the second device 2, and the second device 2 includes a second display device 24. Wherein, the second device 2 is connected to the first server 3 and the second server 4 through the second commenting program 20. Thence, the second device 2 reads the webpage P1 through the second commenting program 20. The second commenting program 20 is shown in a second main window W20 and a second sub window W22 of the second display device 4 while being executed in the second device 2. Accordingly, the webpage P1 is shown in the second main window W20. Afterward, the second device 2 generates the comment C1 through the second commenting program 20 and thus establishes and edits an interface of the comment C1 for showing in the second sub window W22. Herein, the second sub window W22 can be overlapped on the second main window W20 or parallel thereto. Thereby, users are able to compare the webpage P1 that generates the comment C1. After the comment C1 is generated, the second commenting program 20 sends the comment C1 and the website information I1 retrieved from the webpage P1 to the second server 4 for saving. Similar to the first commenting program 10, the second commenting program 20 can be a particular Internet explorer or a current Internet explorer (such as IE, Firefox, Chrome, safari, Opera, and etc.) When the Internet explorer cooperates with an explorer plugin that is able to retrieve the website information and read the comment, other means for surfing the webpage and reading the comment at the same time is also achievable.

In view of the steps S11˜S12, a first user utilizes the first device 1 to connect to each first server 3 or the second server 4 for reading the webpage P1 saved in each server. The comment C1 is read by the second server 4 or from the website information I1 of the webpage P1 in the third device 5. As a result, the comment C1 and the webpage P1 are concurrently displayed, and the first user is able to compare and read the webpage P1 and the comment C1.

In view of the steps S21˜S22, a second user is able to utilize the second device 2 to connect to each first server 3 or the second server for reading the webpage P1 saved in each server. The comment C1 corresponding to the website information I1 of the webpage P1 is generated by the second device 2. Thereafter, the comment C1 and the website information I1 are saved in the second server 4, so that proper annotations are added in the content of the webpage P1.

Further, the first device 1 logins the second server 4 through a first account. The second device 2 logins the second server 4 through a second account. After logining, a tracking function provided by the present invention actively accesses new comments that are generated by the certain user's account or made corresponding to the certain content of the webpage. The means for logining through the account and settings for tracking are as follows. In order to simplify the preferred embodiment, the second preferred embodiment to the fourth preferred embodiment are mainly focused on that the first server reads the webpage, and the third device and the P2P technique for transmitting the comments are omitted. Namely, the P2P technique for transmitting is not limited in the following embodiments.

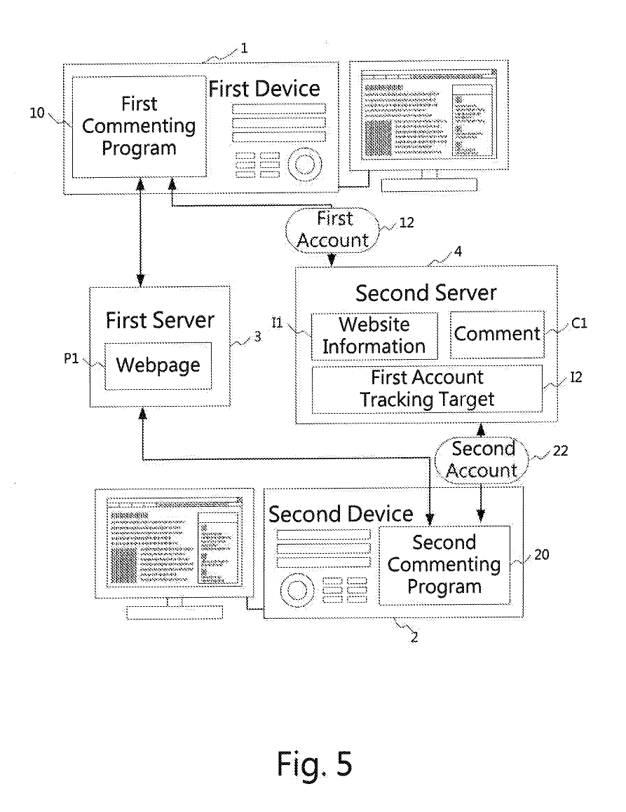

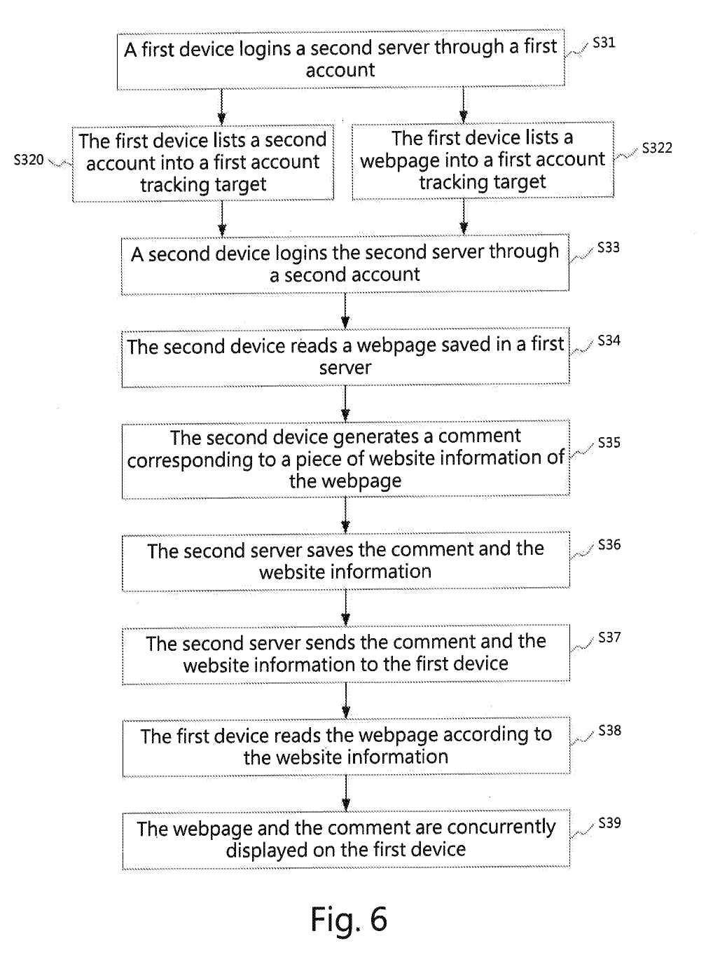

Accompanying with FIGS. 5 and 6, a second preferred embodiment of the present invention shows the tracking means. Referring to FIG. 5, means for setting the tracking function of the present invention comprises a first device 1, a second device 2, a first server 3, and a second server 4. The first device 1 is respectively connected to the first server 3 and the second server 4 through the first commenting program 10. The first device 1 logins the second server 4 through a first account 12. The second device 2 is respectively connected to the first server 3 and the second server 4 through the second commenting program 20. The second device 2 logins the second server 4 through a second account 22.

The first server 3 saves a webpage P1, and the second server 4 saves a piece of website information I1, a comment C1, and a first account tracking target I2. The website information I1 is retrieved from the webpage P1, and the comment C1 is corresponding to the website information I1. The first account tracking target I2 is related to the first account 12, and the second account 22 or the website information I1 is listed.

Similar to the first preferred embodiment, the website information I1 includes a website address of the webpage P1, at least one paragraph of the webpage P1, at least one picture of the webpage P1, at least one video of the webpage P1, at least one piece of embedded external information of the webpage P1, or at least one external website address of the webpage P1.

Referring to FIG. 6, steps for setting the tracking function of the present invention include:

Step S31: a first device logins a second server through a first account;

Step S320: the first device lists a second account into a first account tracking target;

Step S322: the first device lists a webpage into a first account tracking target;

Step S33: a second device logins the second server through a second account;

Step S34: the second device reads a webpage saved in a first server;

Step S35: the second device generates a comment corresponding to a piece of website information of the webpage;

Step S36: the second server saves the comment and the website information;

Step S37: the second server sends the comment and the website information to the first device;

Step S38: the first device reads the webpage according to the website information; and

Step S39: the webpage and the comment are concurrently displayed on the first device.

In step S31, the first device 1 is connected to the second server 4 through the first commenting program 10. The first device 1 logins the second server 4 via the first account 12. Accordingly, the first device 1 sets a first account tracking target I2 of the first account 12. When the comment C1 posted by the second account 22 is to be tracked, the step S320 is launched. The first device 1 sets the first account 12 to track the second account 22 via the first commenting program 10. The first device 1 thence sends the first account tracking target that contains the listed second account 22 to the second server 4. The second server thus saves the first account tracking target I2. If the comment C1 made corresponding to the website information i1 of the webpage is to be tracked, the step S322 is launched. The first device 1 sets the first account 12 to track the website information I1 through the first commenting program 10. The first device 1 thence sends the first account tracking target I2 that contains the listed webpage P1 to the second server 4. Whereby, the second server 4 timely saves the first account tracking target I2.

After the step S320 or the step S322, the step S33 is launched. The second device 2 logins the second server 4 through the second account 22. The steps S34 to S36 are similar to the steps S21 to S23 in the first preferred embodiment. In the step S34, the second device 2 is connected to the first server 3 through the second commenting program 20. The second device 2 thence reads the webpage P1 saved in the first server 3. Subsequently in the step S35, the second device 2 generates the comment C1 through the second commenting program 20 comparing with the website information I1 retrieved from the webpage P1. In the step S36, the second device 2 sends the comment C1 and the website information I1 to the second server 4 through the second commenting program 20. The second server 4 saves the comment C1 and the website information I1. Thereby, the comment C1 is corresponding to the website information i1 and related to the second account 22. Accordingly, the comment C1 is built.

After the step S36, the step S37 is launched. The second server 4 searches according to the first account tracking target I2 that contains the second account 22 or the website information I1. Thereby, the comment C1 related to the second account 22 or the website information I1 is accessed. Afterward, the comment C1 and the website information I1 are sent to the first device 1 that logins the second server 4 via the first account.

In the step S38, the first device 1 reads the webpage P1 according to the website information I1 through the first commenting program 10. In the step S39, the webpage P1 and the comment C1 are concurrently displayed on the first device 1.

In view of the steps S31˜S39, a first user is able to utilize the first device 1 to set the second account 22 or the website information I1 of the webpage P1 into the first account tracking target I2 of the first account 12. After the comment C1 is generated, the comment C1 and the website information I1 sent by the second server 4 are accessed. Herein, the webpage P1 is read according to the website information I1. Thus, the webpage P1 and the comment C2 are concurrently displayed. Preferably, the comment C1 made by the second account 22 or made corresponding to the website information I1 can be timely tracked.

Further, since tracking the new comment corresponding to the website information I1 needs not to be related to the second account 22, the step S34 can be directly launched after the step S322 is finished and the step S33 is skipped. Favorably, the comment C1 made corresponding to the website information I1 can be still tracked. Apparently, the first device 1 can actively list the website information I1 into the first account tracking target I2. Also, the second device 2 can login the second server 4 through the second account 22 and generate the comment C1 corresponding to the website information I1. Accordingly, the second server 4 automatically lists the website information I1 into a second account tracking target (not shown) corresponding to the second account 22, so that a second user can track the website information I1 where he/she has made the comment C1 before.

Besides setting the tracking target, the present invention also allows users to set a code or give authority to an open list of other users for reading the comment. Means for setting the code or giving authority to the open list of other users are depicted as follows.

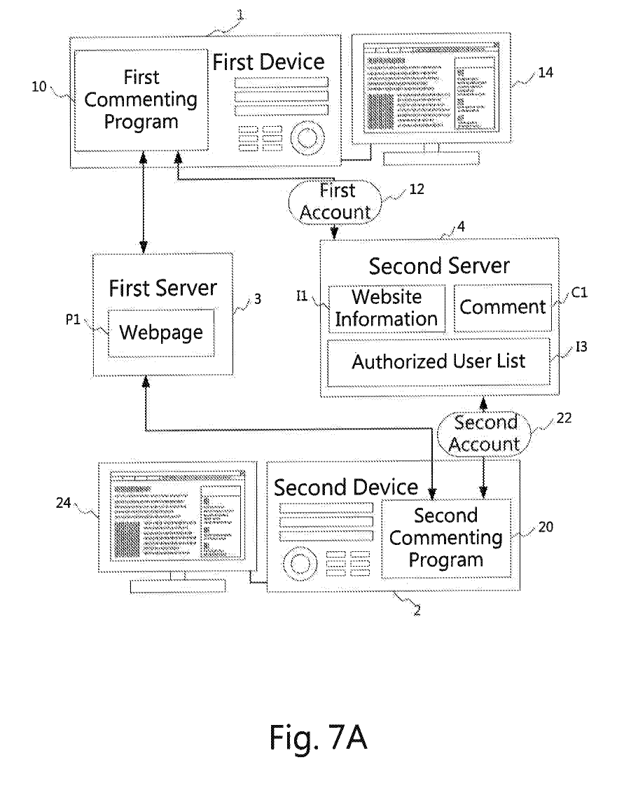

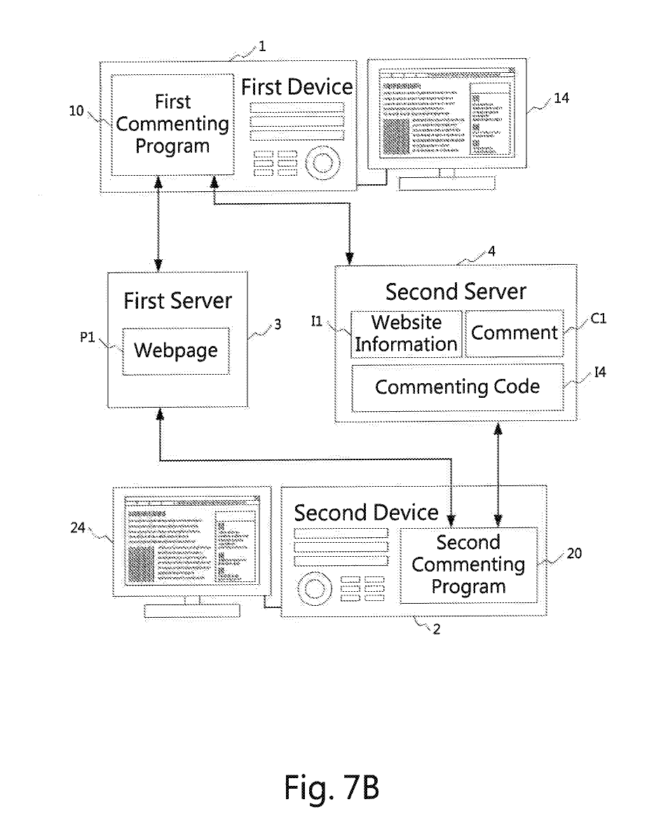

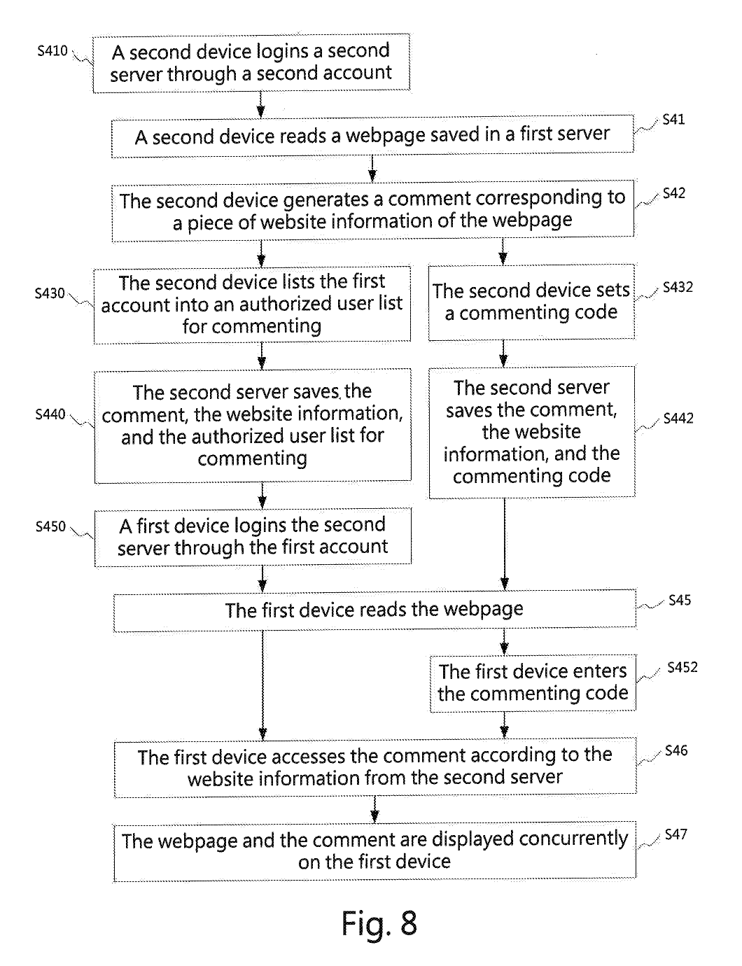

Accompanying with FIGS. 7A, 7B, and 8, a third preferred embodiment of the present invention is shown by two schematic views (I, II) for setting the comment and a flowchart for setting the comment. Referring to FIG. 7, means for giving authority to users in an open list for reading the comments comprises a first device 1, a second device 2, a first server 3, and a second server 4. The first device 1 is respectively connected to the first server 3 and the second server 4 through the first commenting program 10. Thence, the first device 1 logins the second server 4 through a first account 12. The second device 2 is respectively connected to the first server 3 and the second server 4 through the second commenting program 20. The second device 2 further logins the second server 4 through a second account 22.

The first server 3 saves a webpage P1, and the second server 4 saves a piece of website information I1, a comment C1, and an authorized user list I3 for commenting. The website information I1 is retrieved from the webpage P1, and the comment C1 is corresponding to the website information I1. The authorized user list I3 for commenting is related to the comment C1 and the first account 12 is listed.

Referring to FIG. 7B, means for setting a code of the comment comprises a first device 1, a second device 2, a first server 3, and a second server 4. The first device 1 is respectively connected to the first server 3 and the second server 4 through the first commenting program 10. The second device 2 is connected to the first server 3 and the second server 4 through the second commenting program 20.

The first server 3 saves a webpage P1, and the second server 4 saves a piece of website information I1, a comment C1, and a commenting code I4. The website information I1 is retrieved from the webpage P1, the comment C1 is corresponding to the website information I1, and the commenting code I4 is related to the comment C1.

Similar to the first and the second preferred embodiments, the website information I1 includes a website address of the webpage P1, at least one paragraph of the webpage P1, at least one picture of the webpage P1, at least one video of the webpage P1, at least one piece of embedded external information of the webpage P1, or at least one external website address of the webpage P1.

Referring to FIG. 8, steps for setting the comment of the present invention comprises:

Step S410: a second device logins a second server through a second account;

Step S41: a second device reads a webpage saved in a first server;

Step S42: the second device generates a comment corresponding to a piece of website information of the webpage;

Step S430: the second device lists the first account into an authorized user list for commenting;

Step S432: the second device sets a commenting code;

Step S440: the second server saves the comment, the website information, and the authorized user list for commenting;

Step S442: the second server saves the comment, the website information, and the commenting code;

Step S450: a first device logins the second server through the first account;

Step S45: the first device reads the webpage;

Step S452: the first device enters the commenting code;

Step S46: the first device accesses the comment according to the website information from the second server; and

Step S47: the webpage and the comment are displayed concurrently on the first device.

In the step S410, the second device 2 is connected to the second server 4 through the second commenting program 20. The second device 2 thence logins in the second server 4 via the second account 22. The step S410 is a necessary step before setting the authorized user list I3 for commenting. Herein, if users only set the commenting code I4, the step S410 can be skipped, and the step S41 is launched.

The steps S41, S42, and S440 or S442 are similar to the steps S21˜S23 disclosed in the first preferred embodiment. In the step S41, the second device 2 is connected to the first server through the second commenting program 20 so as to read the webpage P1 saved in the first server 3. In the step S42, the second device 2 generates the comment C1 corresponding to the website information I1 retrieved from the webpage P1 through the second commenting program 20.

After the step S42, if users would like to limit other users to read the comment C1, the step S430 is launched. The second device 2 lists the first account 12 into an authorized user list I3 for commenting through the second commenting program 20. Accordingly, the step S440 is conducted. The second device 2 sends the comment C1, the website information I1 corresponding to the webpage P1, and the authorized user list I3 for commenting to the second server 4 through the second commenting program 20. The second server 4 saves the comment C1, the website information I1, and the authorized user list I3 for commenting and allows the authorized user list I3 for commenting to be related to the comment C1. If users would like to set a code for limiting other users to read the comment C1, the step S432 is launched. The second device 2 sets the commenting code I4 through the second commenting program 20. In the step S442, the comment C1, the website information I1, and the commenting code 14 are sent to the second server 4 for saving. Accordingly, the commenting code I4 is set to be related to the comment C1.

After the step S440 or the step S442 is finished, the step S45 is launched. The first device 1 is connected to the first server 3 through the first commenting program 10. The first device 1 thence reads the webpage P1 saved in the server 3. If the steps S430 and S440 are conducted before, the step S450 can be simply launched before the step S46 (or before/after the step S45) to edit the authorized user list I3 for commenting. Herein, the first device 1 is connected to the second server 4 through the first commenting program 10. The first device 1 thence logins the second server 4 via the first account 12. Subsequently, the second server 4 allows the first device 1 to access the comment C1. If the steps S432 and S442 are conducted before, the step S450 can be skipped. If the steps S432 and S442 are conducted before, the step S452 has to be launched for generating the commenting code I4. The first device 1 enters the commenting code I4 through the first commenting program 10, so that the first device 1 is connected to the second server 4 for sending the commenting code I4. After the second server 4 checks the commenting code I4 and finds no problem, the step S46 can be launched. Herein, if the steps S430 and S440 are conducted before, the step S452 can be skipped.

Herein, the steps S46˜S47 are similar to the step S12 in the first preferred embodiment. The second server 4 sends the comment C1 corresponding to the website information i1 to the first device 1. The comment C1 and the webpage P1 are concurrently displayed on the first device 1.

In view of the steps S41˜S47, a second user can edit the authorized user list I3 for commenting or the commenting code I4 while making the comment C1. Accordingly, a first user who owns the first account 12 and is listed in the authorized user list I3 for commenting or knows the commenting code I4 can login via the first account 12 or enter the commenting code I4 so as to read the comment C1. Accordingly, the comment can be only shared with and read by certain users.

Finally, similar to the first preferred embodiment, the first device 1 is respectively connected to the first server 3 and the second server through the first commenting program 10, and the second device 2 is connected to the first server 3 and the second server 4 through the second commenting program 20. Moreover, the method of the present invention utilizes the first device 1 to be connected to the second server 4 through the first commenting program and then further connected to the first server 3 through the second server 4. Also, the second device 2 can be connected to the second server 4 through the second commenting program 20 and then further connected to the first server 3 through the second server 4. The relationship between the connections of the elements is depicted in a fourth preferred embodiment as follows.

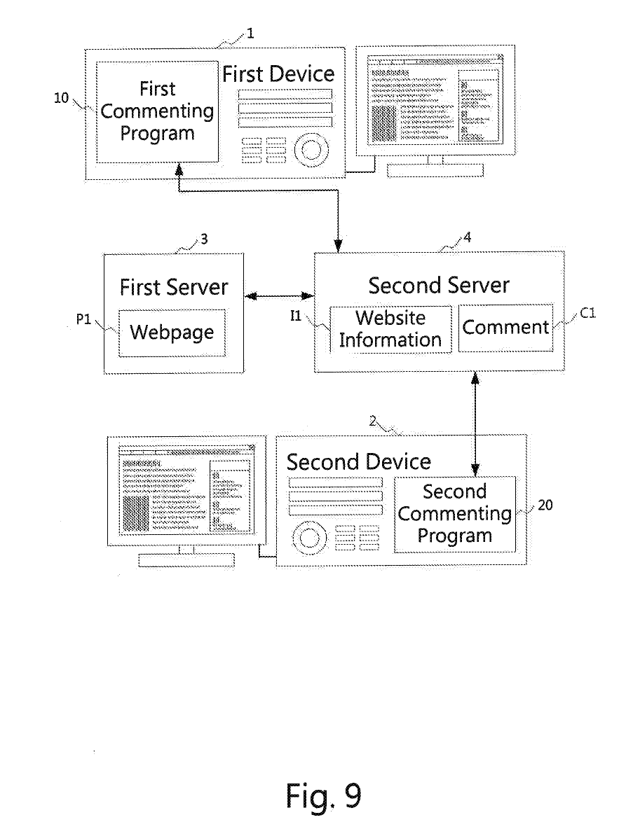

Referring to FIG. 9, a schematic view of the fourth preferred embodiment of the present invention is shown. In the figure, the method of the present invention comprises a first device 1, a second device 2, a first server 3, and a second server 4. Wherein, the first device 1 is connected to the second server 4 through the first commenting program 10 and thence further connected to the first server 3 through the second server 4. The second server 4 is connected to the second server 4 through a second commenting program 20 and thence further connected to the first server 3 through the second server 4.

The processes and steps for executing the method of the present invention in this preferred embodiment are mainly similar to that in the first preferred embodiment. Differently, since the first commenting program 10 of the first device and the second commenting program 20 of the second device 2 are both connected to the second server 4 and thence further connected to the first server 3 through the second server 4, the second server 4 can directly access the website information I1 from the first server 3. Namely, the second server 4 needs not to retrieve and send the website information I1 by means of the first commenting program 10 cooperating with the first device 1 or by means of the second commenting program 20 cooperating with the second device 2 to the second server 4.

Accordingly, referring to the step S23 in the first preferred embodiment, the second server 4 accesses and saves the comment C1 and the website information I1. In this embodiment, the second server 4 accesses the comment C1 from the second device 2 accesses the website information I1 from the first server 3. Accordingly, while the connecting means in this preferred embodiment and the steps as well as processes in the second or the third preferred embodiment are conducted, users can timely track the new-added comments and restrict other users to read the comments. The principles involved therein are mainly the same and thus hereby omitted.

To sum up, the method for sharing and tracking comments on a webpage in accordance with the present invention utilizes a first device to read a webpage for reading at least one comment corresponding to the webpage in accordance with one piece of website information of the webpage through a second server or a third device. Thereby, the webpage and the comment are concurrently displayed on the first device. Generating the comment includes steps of reading a webpage via a second device and applying the second device to generate at least one comment corresponding to at least one piece of website information of the webpage. Thereby, a second server is able to save the comment and the website information. According to afore steps, the present invention allows users to issue their comments corresponding to the content of the webpage while they are surfing the Net. Moreover, the comments can be shared to all or a part of other users. Wherein, the comments are not only corresponding to the website of the webpage but also related to the content of the webpage. Thus, when the content of the webpage is forwarded or cited, users can read the correlated comments directly on the webpage that forwards or cites the original webpage. Accordingly, the comments can be more easily forwarded and shared to more users. Further, the present invention also allows a certain user's account or a certain webpage to be listed into a tracking target, so that users can timely follow the latest comments posted by the certain user's account or made on the certain webpage. Accordingly, the commenting function on the webpage can be served as a communication platform for developing a community that is able to be interactive by sharing the comments on Internet.

1. A method for sharing and tracking comments on a webpage comprising steps of:
a first device reading a webpage; and
said first device sending at least one piece of website information of said webpage to a second server or at least one third device so as to access at least one comment corresponding to said website information; said webpage and said comment being concurrently displayed on said first device.

2. The method as claimed in claim 1, wherein, said first device reads said webpage from said first device, a first server, or said second server.

3. The method as claimed in claim 2, wherein, said first device is directly connected to said first server, or said first device is connected to said second server and thence to said first server through said second server.

4. The method as claimed in claim 1, wherein, said first server accesses said comment from said second server or said third device.

5. The method as claimed in claim 1, wherein, said third device accesses said comment from said second server.

6. The method as claimed in claim 1, wherein, said first device reads said webpage, retrieves said website information, sends said website information, or reads said comment through a commenting program.

7. The method as claimed in claim 6, wherein, said commenting program is directed to an explorer program or an explorer program with an explorer plugin; said first device reads said webpage through said explorer program and applies said explorer program or said explorer plugin to retrieve said website information, send said website information, or read said comment.

8. The method as claimed in claim 1, wherein, said first device logins and connects to said second server through a first account.

9. The method as claimed in claim 8, wherein, said first device lists said website information into a tracking target of said first account.

10. The method as claimed in claim 1, wherein, generating said comment including steps of:
reading said webpage via a second device; and
applying said second device to generate said comment corresponding to said website information of said webpage; said second server accessing and saving said comment and said website information.

11. The method as claimed in claim 10, wherein, said second device reads said webpage from said second device, a first server, or said second server.

12. The method as claimed in claim 11, wherein, said second device is directly connected to said first server, or said second device is connected to said second server and thence to said first server through said second server.

13. The method as claimed in claim 10, wherein, said second device reads said webpage, retrieves said website information, generates said comment, sends said comment and said website information, or reads said comment through a commenting program.

14. The method as claimed in claim 13, wherein, said commenting program is directed to an explorer program or an explorer program with an explorer plugin; said second device reads said webpage through said explorer program and applies said explorer program or said explorer plugin to retrieve said website information, generates said comment, send said comment and said website information, or read said comment.

15. The method as claimed in claim 10, wherein, said second device logins and connects to said second server through a second account.

16. The method as claimed in claim 15, wherein, said first device logins and connects to said second server through a first account; said first device lists said second account into a tracking target of said first account.

17. The method as claimed in claim 15, wherein, said first device logins and connects to said second server through a first account; said second device lists said first account into an authorized user list of said comment.

18. The method as claimed in claim 10, wherein, said second device sets a code corresponding to said comment; after said second server or said third device enters said first code to said first device, said first device is allowed to read said comment.

19. The method as claimed in claim 1, wherein, said website information includes a website address of said webpage, at least one paragraph of said webpage, at least one picture of said webpage, at least one video of said webpage, at least one piece of embedded external information of said webpage, or at least one external website address of said webpage.
